(19) United States
(12) Patent Application Publication
(10) Pub. No.: US 2006/0016844 A1
(43) Pub. Date: Jan. 26, 2006

(54) Fastener driving tool

(76) Inventors: Yoshinori Ishizawa, Ibaraki (JP); Hiroki Kitagawa, Ibaraki (JP); Masashi Nishida, Ibaraki (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/176,289

(22) Filed: Jul. 8, 2005

(30) Foreign Application Priority Data
Jul. 9, 2004 (JP) P2004-203681

(51) Int. Cl. B25C 1/04

(52) U.S. Cl. 227/130

(57) ABSTRACT

A top cover is made of a metal and constituted to provide substantially a bowl-like shape extended from an upper side of an exhaust cover in a side direction. Further, a damping member including an elastic member is provided between the top cover and the exhaust cover. Further, an expansion chamber constituting a space of communicating with an exhaust path and the exhaust port for communicating the expansion chamber to the atmosphere are provided and the damping member is provided to be pinched with an exposed thread at a surrounding of the expansion chamber.

### BACKGROUND OF THE INVENTION

1. Field of the Invention

The present invention relates to a technology of protecting a periphery of an exhaust cover of a fastener driving tool utilizing compressed air or combustion gas.

2. Description of the Related Art

An exhaust cover is, along a fastener driving direction, projected rearward from a handle portion and therefore, when operation is carried out in a narrow place, the exhaust cover and a top cover attached to the exhaust cover frequently collides with a surrounding. Therefore, it is requested to ensure durability of the exhaust cover and the top cover and reduce a total height of the fastener driving tool by thinning the top cover. A technology of a background art with regard to the exhaust cover and the top cover will be explained as follows.

As shown by FIG. 8, there is a fastener driving tool provided with a top cover 2 formed by a thin plate made of iron to be flush with an exhaust cover 3 such that an exhaust port 8 is projected.

JP-A-11-129167 is described as follows. A main body and an exhaust cover can be protected by providing a top cover comprising hard rubber or the like to cover substantially a total periphery of the exhaust cover.

Japanese Patent No. 3397040 is described as follows. By providing a protection cover made of rubber to cover a total of an exhaust cover, a main body can be prevented from being impaired.

### SUMMARY OF THE INVENTION

According to the constitution of FIG. 8, the projected exhaust port 8 is liable to be caught by a surrounding and there is a case in which a root portion of the top cover is concentrated with a bending load to be destructed. Further, when the top cover 2 collides with the surrounding, an impact stress is generated between the top cover 2 and the exhaust cover 3. Further, in fastening operation, there is a case in which in accordance with rapidly displacing the fastener driving tool by reaction, the top cover 2 is deformed by an inertia force, strong chattering (repetition of impact) is brought about between the top cover 2 and the exhaust cover 3 to destruct the exhaust cover 3. Further, according to the constitution of FIG. 8, there is a case in which a gap other than the exhaust port 8 is produced between the top cover 2 and the exhaust cover 3 and compressed air is leaked from the gap.

According to the constitutions of JP-A-11-129167 and Japanese Patent No. 3397040, there is a case in which when the exhaust cover comprising rubber (or protection cover) collides with, for example, a sharp member, the exhaust cover is bored with a hole or cut. Further, a total height of the fastener driving tool is increased by setting the thickness to be large in order to ensure strength.

It is an object of the invention to provide a fastener driving tool resolving the above-described drawbacks of the background art, having high durability, and having a thin protection cover without leaking exhaust compressed air from other than an exhaust port.

In a fastener driving tool including a barrel portion substantially in a cylindrical shape extended in an up and down direction, an nose portion extended from the barrel portion to a lower side, a handle portion extended from the barrel portion substantially in a side direction, an exhaust path which is an exhaust path provided at an upper portion of the barrel portion for communicating inside of the barrel portion and the atmosphere, and a top cover for covering the exhaust path, the fastener driving tool is constituted such that the top cover is made of a metal and is provided with substantially a bowl-like shape extended from an upper side of the barrel portion in a side direction. When constituted in this way, since the top cover is made of a metal, even when the top cover is thin, strength thereof can be ensured. Further, since the top cover is substantially constituted by the bowl-like shape, an edge thereof is not projected in a side direction and therefore, even when the top cover collides with a surrounding, the top cover is not caught thereby, stresses are not concentrated and the top cover is difficult to be destructed. Therefore, durability of the top cover can be promoted and a thickness thereof can be thinned.

Further, the fastener driving tool is constituted to include a damping member comprising an elastic member between the top cover and the barrel portion. When constituted in this way, the top cover and an outer frame portion can be prevented from colliding with each other. Therefore, durability of the top cover can be promoted.

Further, an expansion chamber constituting a space for communicating with the exhaust path and the exhaust port communicating with the atmosphere from the expansion chamber are provided between the barrel portion and the top cover, and the damping member is provided to be pinched with an exposed thread at a surrounding of the expansion chamber. When constituted in this way, a gap is not produced at other than the exhaust port between the top cover and the barrel portion. Therefore, exhaust compressed air can be prevented from being leaked from other than the exhaust port.

Further, the damping member is constituted to include a first hole portion penetrated at a portion thereof opposed to the expansion chamber. When constituted in this way, a pressure difference between upper surface and lower surface of the damping member is reduced and the damping member can be prevented from being deformed excessively.

Further, the top cover is constituted such that the top cover includes an attaching seat portion brought into contact with the barrel portion and the top cover and the barrel portion are connected by a bolt at the attaching seat portion. When constituted in this way, the top cover can firmly be fixed while maintaining the exposed thread of the damping member constant.

Further, the damping member is constituted to include a second hole portion engaged with the attaching seat portion. When constituted in this way, the top cover is firmly positioned.

According to the invention, there can be provided the fastener driving tool having high durability, and including a protection cover having a thin thickness without leaking exhaust compressed air from other than the exhaust port.

### BRIEF DESCRIPTION OF THE DRAWINGS

FIG. 1 is a sectional view of a total structure of a fastener driving tool according to an embodiment of the invention;

FIG. 2 is a front view of an essential portion of the fastener driving tool according to the embodiment of the invention;

FIG. 3 is a left side view of an essential portion viewed from B direction of FIG. 1;

FIG. 4 is a view enlarging portion A of FIG. 1;

FIG. 5 is a view showing a state of deforming a protection cover to an upper side in FIG. 4;

FIG. 6 is a view showing a state of deforming the protection cover to a lower side in FIG. 4;

FIG. 7 is a disassembled perspective view of an essential portion of the fastener driving tool according to the embodiment of the invention; and

FIG. 8 is a sectional view of a structure of an essential portion showing an example of a fastener driving tool of a background art.

### DETAILED DESCRIPTION OF THE PREFFERED EMBODIMENTS

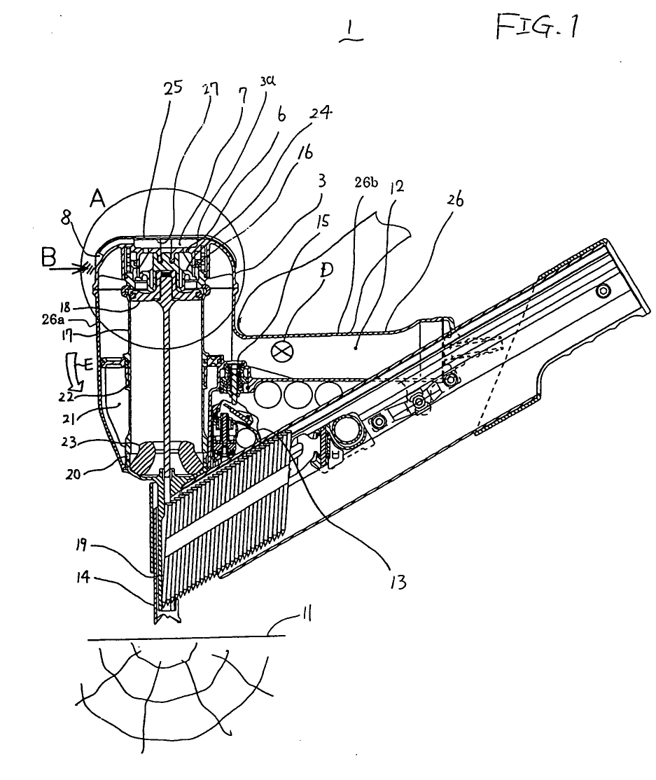

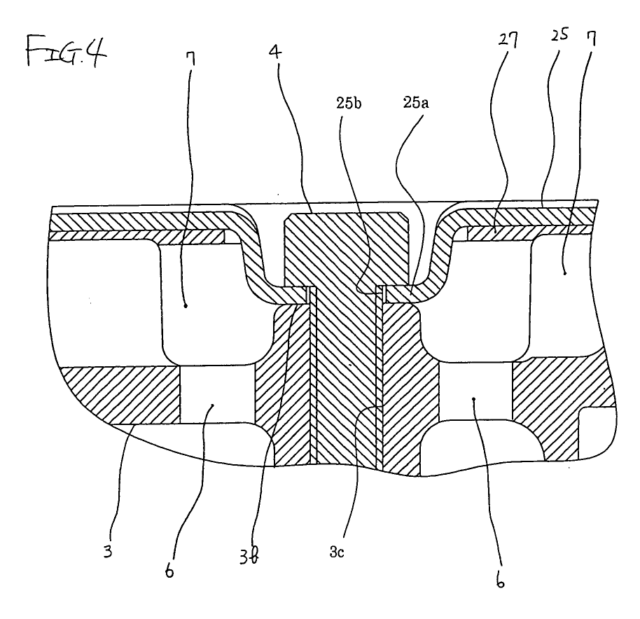

A fastener driving tool according to an embodiment of the invention will be explained in reference to FIG. 1 through FIG. 7.

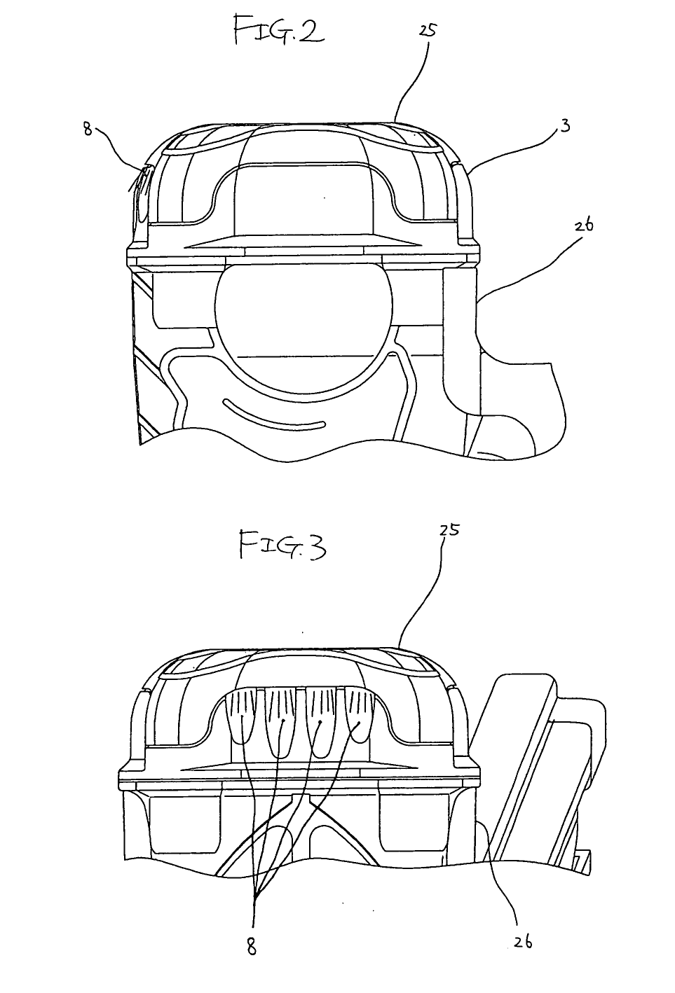

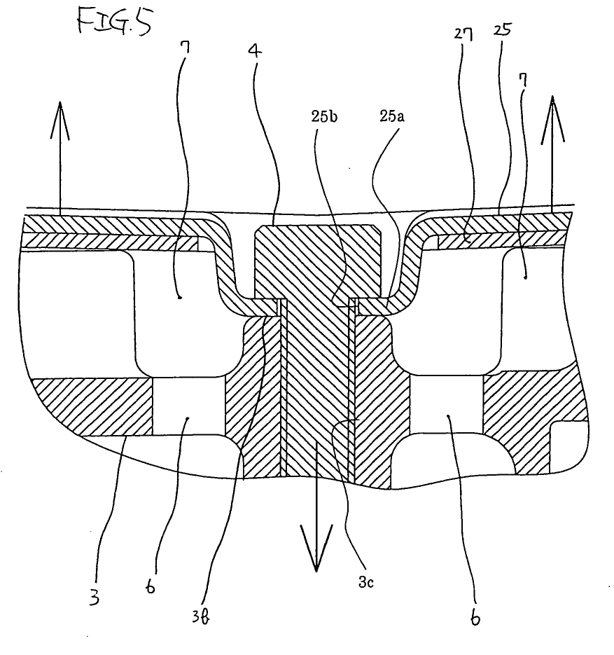

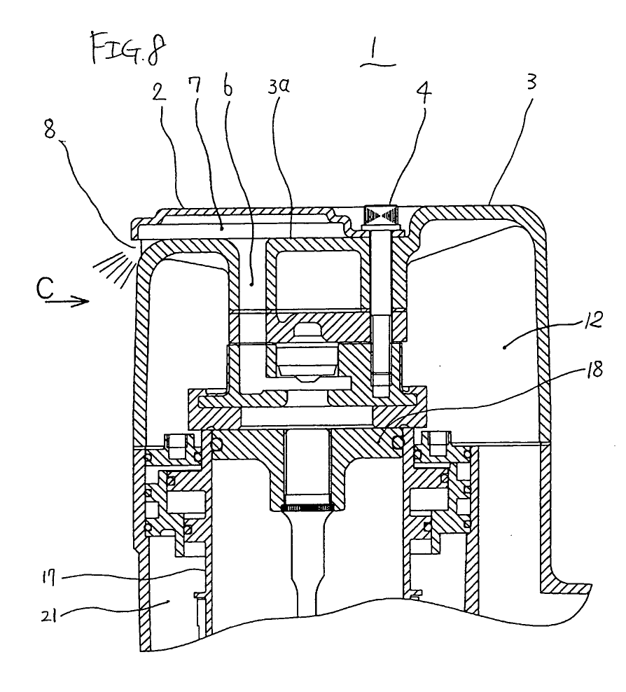

An top cover 25 will be explained in reference to FIG. 2, FIG. 4 and FIG. 7.

As shown by FIG. 7, the top cover 25 is formed substantially in a bowl-like shape by pressing a stainless steel plate having a thickness of 1.2 mm. As shown by FIG. 4, the top cover 25 is projected with an attaching seat portion 25a brought into contact with the exhaust cover 3. Also a side of the exhaust cover 3 is projected with an attaching seat portion 3b at a position in correspondence with the attaching seat portion 25a, and the attaching seat portion 3b is provided with a screw hole 3c. By inserting a bolt 4 through the bolt hole 25b to be screwed with the screw hole 3c, the top cover 25 is attached to the exhaust cover 3 such that the attaching seat portion 25a and the attaching seat portion 3b are brought into contact with each other. As shown by FIG. 2, the top cover 25 is extended to cover from an upper face to a side face of the exhaust cover 3, and covers four pieces of bolts 30 for fastening the exhaust cover 3 and a barrel portion 26a of a body 26 constituting an outer frame portion.

The top cover 25 is made of a metal and therefore, even when the top cover 25 is thinned more than that made of rubber, strength thereof can be ensured. The top cover is constituted substantially by the bowl-like shape, an end portion thereof is formed to be in line with the exhaust cover 3, there is not a portion considerably projected to an outer side and therefore, when the top cover 25 interferes with a surrounding, the top cover 25 is not caught thereby. The end portion of the top cover is extended to cover the bolts 30 and therefore, the bolt 30 is not seen from outside and an outlook of the fastener driving tool 1 is promoted.

A damping member 27 is pinched between the exhaust cover 3 and the top cover 25. The damping member 27 is constituted by rubber having a thickness of 1 mm and is pinched therebetween with an exposed thread of 0.4 mm. Further, a portion of the damping member 27 in correspondence with the attaching seat portion 3b is provided with a locking hole 27a constituting a second hole portion to be engaged with the attaching seat portion 3b. A vicinity of the locking hole 27a is provided with a vent hole 27b constituting a first hole portion for communicating a face of the damping member 27 on a side of the exhaust cover 3 and a face thereof on a side of the top cover 25.

An upper end face 3a of the exhaust cover 3 is recessed with an expansion chamber 7 for gradually lowering pressure of compressed air to be exhausted. Inside of the expansion chamber 7 is provided with an air path 6 for communicating inside of the fastener driving tool 1 and the expansion chamber 7. A portion in a peripheral direction of the expansion chamber 7 is recessed with an exhaust port 8 for communicating inside of the expansion chamber 7 and the atmosphere. A plurality of ribs 3d are projected from a bottom portion to an upper side of the expansion chamber 7 to extend to a height substantially the same as that of the upper end face 3a. The damping member 27 is pinched between the upper end face 3a of the exhaust cover 3 and the ribs 3d and the top cover 25 with an exposed thread such that a gap is not produced at other than the exhaust port 8.

Operation of the fastener driving tool 1 will be explained in reference to FIG. 1.

There is shown a state in which a main body of the fastener driving tool 1 is connected with an air hose, not illustrated, to store compressed air. Compressed air is stored in a pressure accumulating chamber 12.

When a trigger valve 15 is made ON by executing both of operation of pulling a trigger 13 and operation of pressing a push lever 14 to wood 11, a main valve 16 is moved to an upper side, and the pressure accumulating chamber 12 and an upper side of a piston 18 are communicated with each other. Further, the pressure accumulating chamber 12 and the air path 6 are blocked from each other.

The piston 18 strikes a nail 19 to the wood 11 while rapidly moving to a side of a lower dead center by compressed air flowing from the pressure accumulating chamber 12 to an upper side of the piston 18 in the cylinder 17. Air on a lower side of the piston 18 in the cylinder 17 flows into a returning chamber 21 via an air path 20, and when the piston 18 passes through an air path 22, a portion of compressed air on the upper side of the piston 18 flows into the returning chamber 21 via the air path 22. The piston 18 collides with a piston bumper 23 at the lower dead center, and extra energy of the piston 18 is absorbed by deforming the piston bumper 23.

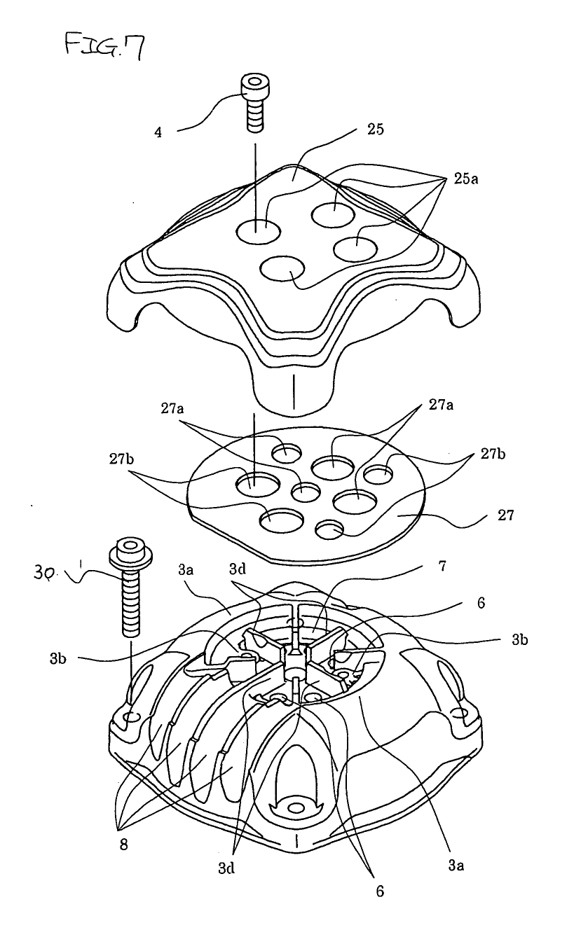

A state of the top cover 25 and the damping member 27 in striking operation will be explained in reference to FIG. 1, FIG. 4 and FIG. 6.

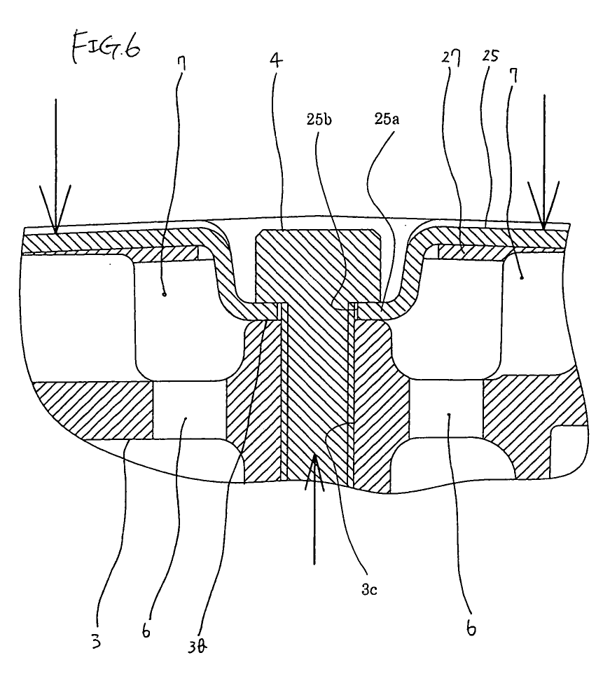

As shown by FIG. 1, when the piston 18 collides with the piston bumper 23, the fastener driving tool 1 is rapidly displaced to pivot in an arrow mark E direction centering on a point D of a handle portion 26b. At this occasion, the top cover 25 is operated with an inertia force, and as shown by an arrow mark in FIG. 5, a surrounding of the attaching seat portion 25a is rapidly displaced to an upper side. Thereafter, the fastener driving tool 1 is going to be back to original state by a force of the hand holding the handle portion 16b. At this occasion, the top cover 25 is operated with an inertia force again, and as shown by an arrow mark in FIG. 6, the surrounding of the attaching seat portion 25a is displaced to the lower side. Although according to the fastener driving tool of the background art, repetition of the rapid displacements brings about chattering (repetition of impact) between the top cover 25 and the exhaust cover 3, according to the embodiment, the damping member 27 prevents the top cover 25 and the exhaust cover from colliding with each other and damps vibration of the top cover 25. Further, the damping member 27 is pinched between the top cover 25 and the exhaust cover 3 with an exposed thread and therefore, even in a state in which a portion of the top cover 25 is displaced in a direction of being remote from the exhaust cover 3, contact between the damping member 27 and the top cover 25 is maintained, and the damping member 27 can effectively damp the vibration. Further, the damping member 27 can damp an impact force exerted to the top cover 25 not only in the striking operation but also when the top cover 25 collides with a surrounding.

When the trigger valve 15 is made OFF by returning the trigger 13 or stopping operation of pressing the push lever 14 to the wood 11, the main valve 16 is moved to a lower side.

The main valve 16 is closed, the pressure accumulating chamber 12 and the upper side of the piston 18 in the cylinder 17 are blocked from each other, and the upper side of the piston 18 in the cylinder 17 communicates with the atmosphere by disengagement of the main valve 16 and an exhaust rubber 24. The lower side of the piston 18 is pressed by compressed air accumulated in the returning chamber 21 and the piston 18 is moved rapidly to a side of an upper dead center. Compressed air on the upper side of the piston 18 is exhausted to the atmosphere from the exhaust port 8 by way of the air path 6 and the expansion chamber 7 to return to an initial state.

Although at this occasion, compressed air on the upper side of the piston 18 in the cylinder 17 after striking the nail 19 flows into the expansion chamber 7 by way of the air path 6 and thereafter exhausted to the atmosphere from the exhaust port 8, the damping member 27 is pinched therebetween such that the gap is not produced at other than the exhaust port 8 and therefore, compressed air is not leaked from a gap. Further, compressed air flowing to the expansion chamber 7 also flows to between the top cover 25 and the damping member 27 by way of the vent hole 27b and therefore, a pressure difference is not produced between upper surface and lower surface of the damping member 27. Therefore, a large force is not exerted to the damping member 27, and the damping member 27 is not vibrated to destruct, or strange sound is not emitted by vibration.

The above-described is a stroke of striking a single piece of the nail 19 to the wood 11.

1. A fastener driving tool comprising:
a barrel portion substantially in a cylindrical shape extended in an up and down direction;
an nose portion extended from the barrel portion to a lower side;
a handle portion extended from the barrel portion substantially in a side direction;
an exhaust path which is an exhaust path provided at an upper portion of the barrel portion for communicating inside of the barrel portion and the atmosphere; and
a top cover for covering the exhaust path;
wherein the top cover is made of a metal and is provided with substantially a bowl-like shape extended from an upper side of the barrel portion in a side direction.

2. The fastener driving tool according to claim 1, further comprising a damping member comprising an elastic member disposed between the top cover and the barrel portion.

3. A fastener driving tool comprising:
a barrel portion substantially in a cylindrical shape extended in an up and down direction;
an nose portion extended from the barrel portion to a lower side;
a handle portion extended from the barrel portion substantially in a side direction;
an exhaust port provided at an upper portion of the barrel portion; and
a top cover for covering the exhaust port;
wherein a damping member comprising an elastic member is provided between the top cover and the barrel portion.

4. The fastener driving tool according to claim 2, characterized in that an expansion chamber constituting a space for communicating with the exhaust path and the exhaust port for communicating the expansion chamber with the atmosphere are provided between the barrel portion and the top cover, and the damping member is pinched with an exposed thread at a surrounding of the expansion chamber.

5. The fastener driving tool according to claim 4, characterized in that the damping member includes a first hole portion penetrated at a portion thereof opposed to the expansion chamber.

6. The fastener driving tool according to claim 2, characterized in that the top cover includes an attaching seat portion brought into contact with the barrel portion, and the top cover and the barrel portion are connected by a bolt at the attaching seat portion.

7. The fastener driving tool according to claim 6, characterized in that the damping member includes a second hole portion engaged with the attaching seat portion.
